(19) United States
(12) Patent Application Publication
(10) Pub. No.: US 2026/0120604 A1
(43) Pub. Date: Apr. 30, 2026

(54) DISPLAY CONTROLLER FOR AGING COMPENSATION

(71) Applicant: NXP B.V., Eindhoven (NL)

(72) Inventors: Michael Andreas Staudenmaier, Munich (DE); Sven Haelsig, Munich (DE); Vincent Aubineau, Issy-les-Moulineaux (FR)

(21) Appl. No.: 19/360,090

(22) Filed: Oct. 16, 2025

(30) Foreign Application Priority Data
Oct. 31, 2024 (EP) 24315503.3

(51) Int. Cl. G09G 3/20; G09G 3/3225

(52) U.S. Cl. CPC G09G 3/2003; G09G 3/3225; G09G 2320/041; G09G 2320/045; G09G 2320/0666

(57) ABSTRACT

A display controller includes an image data interface for obtaining first image data, a temperature data interface, an aging compensation quantity interface for obtaining a first aging compensation quantity for a first color component of a first pixel from a first memory element, and a processing unit for rendering display data at a display refresh frequency. The processing unit determines a first initial intensity of the first color component based on the first image data, a first corrected intensity of the first color component based on the first initial intensity of the first color component and the first aging compensation quantity, and a first incremental aging effect datum for the first color component based on the first initial intensity or the first corrected intensity of the first color component and (ii) a first temperature datum. Display data is output which includes the first corrected intensity of the first color component.

### TECHNICAL FIELD

This disclosure generally relates to a display controller, a method, a display system, and a computer program and more specifically to ways of compensating for aging effects of a display device.

### BACKGROUND

The pixels in various types of displays can exhibit a significant aging effect. Over time, the intensity of the pixels degrades. This degradation may depend on several parameters, such as the color of the pixel, the amount of usage of the pixel, e.g. how long it has been used and at what intensity, and at what temperatures the pixel has been operated.

Since the degradation may be dependent on pixel color, as time goes by, the color temperature of the display may change. For example, a screen that was initially white at the beginning of its life might increasingly get color cast over time.

### SUMMARY

According to a first aspect of the present disclosure, there is provided a display controller comprising:
an image data interface for obtaining first image data from a first frame buffer;
a temperature data interface for obtaining a first temperature datum from a first temperature sensor;
an aging compensation quantity interface for obtaining a first aging compensation quantity for
a first color component of a first pixel from a first memory element;
a processing unit configured for rendering display data at a display refresh frequency, wherein the processing unit is configured to:
determine a first initial intensity of the first color component of the first pixel based on the first image data,
determine a first corrected intensity of the first color component of the first pixel based on the first initial intensity of the first color component of the first pixel and the first aging compensation quantity, and
determine a first incremental aging effect datum for the first color component of the first pixel based on (i) the first initial intensity or the first corrected intensity of the first color component of the first pixel and (ii) the first temperature datum;
a display data interface for outputting the display data comprising the first corrected intensity of the first color component of the first pixel to a display device at the display refresh frequency.

In one or more embodiments, the display device comprises light emitting diodes.

In one or more embodiments, the first aging compensation quantity may comprise at least one coefficient of a polynomial.

In one or more embodiments, the display controller further comprises an aging accumulator wherein the aging accumulator is configured to update, at the display refresh frequency, a first intermediate accumulated aging effect datum based on the first incremental aging effect datum; and wherein the aging accumulator is further configured to update a first accumulated aging effect datum based on the first intermediate accumulated aging effect datum at a lifetime accumulation frequency that is lower than the display refresh frequency and/or triggered by a first user-initiated action.

In one or more embodiments, the display controller further comprises an aging accumulator wherein the aging accumulator is configured to update a first accumulated aging effect datum based on the first incremental aging effect datum at the display refresh frequency.

In one or more embodiments, the processing unit is further configured to update the first aging compensation quantity for the first color component of the first pixel based on the first accumulated aging effect datum; wherein the update of the first aging compensation quantity is triggered by a second user-initiated action and/or performed periodically at an update frequency, wherein the update frequency is lower than the display refresh frequency.

In one or more embodiments, the aging compensation quantity interface is further configured for obtaining a second aging compensation quantity for a second color component of the first pixel from the first memory element and a third aging compensation quantity for a third color component of the first pixel from the first memory element;
wherein the processing unit is further configured to:
   determine a second initial intensity of the second color component of the first pixel based on the first image data, and
   determine a third initial intensity of the third color component of the first pixel based on the first image data,
   determine a second corrected intensity of the second color component of the first pixel based on the second initial intensity of the second color component of the first pixel and the second aging compensation quantity, and
   determine a third corrected intensity of the third color component of the first pixel based on the third initial intensity of the third color component of the first pixel and the third aging compensation quantity,
   determine a second incremental aging effect datum for the second color component of the first pixel based on the second initial intensity or the second corrected intensity of the second color component of the first pixel and the first temperature datum;
   determine a third incremental aging effect datum for the third color component of the first pixel based on the third initial intensity or the third corrected intensity of the third color component of the first pixel and the first temperature datum;
   wherein the display data interface is further configured for outputting display data comprising the second corrected intensity of the second color component and the third corrected intensity of the third color component of the first pixel to the display device at the display refresh frequency.

In one or more embodiments, the aging accumulator is further configured to update, at the display refresh frequency, a second intermediate accumulated aging effect datum based on the second incremental aging effect datum, and wherein the aging accumulator is further configured to update a second accumulated aging effect datum based on the second intermediate accumulated aging effect datum periodically at the lifetime accumulation frequency and/or triggered by the first user-initiated action; and
wherein the aging accumulator is further configured to update, at the display refresh frequency, a third intermediate accumulated aging effect datum based on the third incremental aging effect datum, and wherein the aging accumulator is further configured to update a third accumulated aging effect datum based on the third intermediate accumulated aging effect datum at the lifetime accumulation frequency and/or triggered by the first user-initiated action.

In one or more embodiments, the aging accumulator is further configured to update a second accumulated aging effect datum based on the second incremental aging effect datum at the display refresh frequency, and wherein the aging accumulator is further configured to update a third accumulated aging effect datum based on the third incremental aging effect datum at the display refresh frequency.

In one or more embodiments, the processing unit is further configured to update the second aging compensation quantity for the second color component of the first pixel based on the second accumulated aging effect datum, and wherein the processing unit is further configured to update the third aging compensation quantity for the third color component of the first pixel based on the third accumulated aging effect datum; wherein the update of the second and third aging compensation quantity is triggered by the second user-initiated action and/or performed periodically at an update frequency, wherein the update frequency is lower than the display refresh frequency.

In one or more embodiments, the image data interface is further configured for obtaining second image data from a second frame buffer and wherein the processing unit is further configured to determine the first initial intensity of the first color component of the first pixel based on the first image data and the second image data.

In one or more embodiments the processing unit is further configured to:
determine the second initial intensity of the second color component of the first pixel based on the first image data and the second image data, and
determine the third initial intensity of the third color component of the first pixel based on the first image data and the second image data.

According to a second aspect of the present disclosure, there is provided a display system comprising:
a display controller comprising:
an image data interface for obtaining first image data from a first frame buffer;
a temperature data interface for obtaining a first temperature datum from a first temperature sensor,
an aging compensation quantity interface for obtaining a first aging compensation quantity for a first color component of a first pixel from a first memory element;
a processing unit configured for rendering display data at a display refresh frequency, wherein the processing unit is configured to:
determine a first initial intensity of the first color component of the first pixel based on the first image data,
determine a first corrected intensity of the first color component of the first pixel based on the first initial intensity of the first color component of the first pixel and the first aging compensation quantity, and
determine a first incremental aging effect datum for the first color component of the first pixel based on (i) the first initial intensity or the first corrected intensity of the first color component of the first pixel and (ii) the first temperature datum, and
a display data interface for outputting the display data comprising the first corrected intensity of the first color component of the first pixel to a display device at the display refresh frequency; and
a display connectable to the display data interface of the display controller;
the first memory element; the second memory element; the first frame buffer; and the first temperature sensor.

According to a third aspect of the present disclosure, there is provided a method performed by a display controller comprising:
obtaining first image data from a first frame buffer via an image data interface;
obtaining a first temperature datum from a first temperature sensor;
obtaining a first aging compensation quantity for a first color component of a first pixel from a first memory element via an aging compensation quantity interface;
rendering, by a processing unit of the display controller, display data at a display refresh frequency, the rendering comprising:
determining a first initial intensity of the first color component of the first pixel based on the first image data,
determining a first corrected intensity of the first color component of the first pixel based on the first initial intensity of the first color component of the first pixel and the first aging compensation quantity, and
determining a first incremental aging effect datum for the first color component of the first pixel based on (i) the first initial intensity or the first corrected intensity of the first color component of the first pixel and (ii) the first temperature datum; and
outputting, via a display data interface, the display data comprising the first corrected intensity of the first color component of the first pixel to a display device at the display refresh frequency.

According to a fourth aspect of the present disclosure, there is provided a computer program comprising instructions that, when executed by a display controller, causes the display controller to perform a method according to any aspect provided herein.

According to a fifth aspect of the present disclosure, there is provided a non-transitory machine-readable storage medium comprising instructions that, when executed by a display controller, causes the display controller to:
obtain first image data from a first frame buffer via an image data interface;
obtain a first temperature datum from a first temperature sensor;
obtain a first aging compensation quantity for a first color component of a first pixel from a first memory element via an aging compensation quantity interface;
render, by a processing unit of the display controller, display data at a display refresh frequency, the rendering comprising:
determine a first initial intensity of the first color component of the first pixel based on the first image data,
determine a first corrected intensity of the first color component of the first pixel based on the first initial intensity of the first color component of the first pixel and the first aging compensation quantity, and
determine a first incremental aging effect datum for the first color component of the first pixel based on (i) the first initial intensity or the first corrected intensity of the first color component of the first pixel and (ii) the first temperature datum; and
output, via a display data interface, the display data comprising the first corrected intensity of the first color component of the first pixel to a display device at the display refresh frequency.

The above discussion is not intended to represent every example embodiment or every implementation within the scope of the current or future claim sets. The figures and detailed description that follow also exemplify various example embodiments. Various example embodiments may be more completely understood in consideration of the following detailed description in connection with the accompanying drawings.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1: an example embodiment of a display system comprising a display controller;

FIG. 2A: an example embodiment showing how luminance may degrade as a function of integrated intensity;

FIG. 2B: an example embodiment showing how luminance may degrade as a function of integrated temperature;

FIG. 3: an example embodiment of an accumulated aging datum;

FIG. 4: an example embodiment illustrating two-stage accumulation; and

FIG. 5: an example embodiment illustrating one-stage accumulation; and

FIG. 6: an example embodiment of a method performed by a display controller.

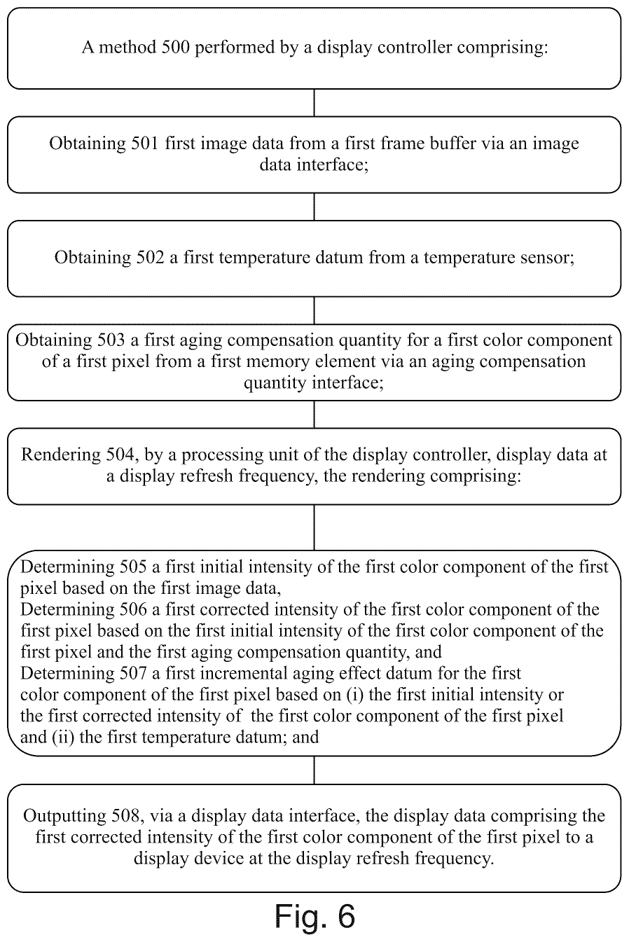

### DETAILED DESCRIPTION

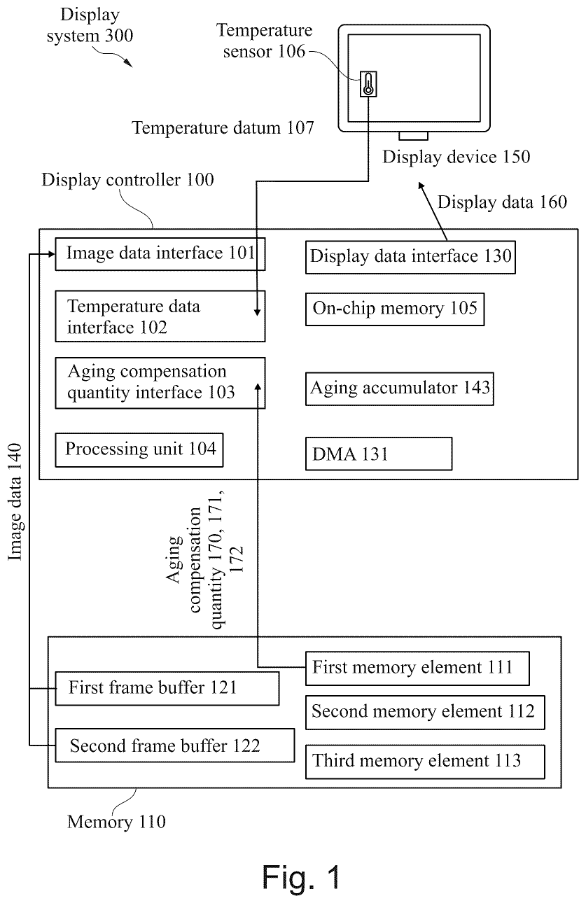

FIG. 1 shows an exemplary display controller 100 comprising:
an image data interface 101 for obtaining first image data from a first frame buffer;
a temperature data interface 102 for obtaining a first temperature datum from a first temperature sensor 106;
an aging compensation quantity interface 103 for obtaining a first aging compensation quantity 170 for a first color component of a first pixel from a first memory element;
a processing unit 104 configured for rendering display data 160 at a display refresh frequency, wherein the processing unit 104 is configured to:
determine a first initial intensity of the first color component of the first pixel based on the first image data,
determine a first corrected intensity of the first color component of the first pixel based on the first initial intensity of the first color component of the first pixel and the first aging compensation quantity 170, and
determine a first incremental aging effect datum 190 for the first color component of the first pixel based on (i) the first initial intensity or the first corrected intensity of the first color component of the first pixel and (ii) the first temperature datum;
a display data interface 130 for outputting the display data 160 comprising the first corrected intensity of the first color component of the first pixel to a display device 150 at the display refresh frequency.

The display controller 100 could also perform additional functions like blending/combining multiple frames into one frame and the aging compensation described herein may come after these steps.

In the exemplary embodiment of FIG. 1, the term “datum” is used to relate to at least one numerical value but it may comprise several numerical values. Note that in this exemplary embodiment, a temperature datum 107 is not obtained from the first temperature sensor 106 at the display refresh frequency (e.g. 60 Hertz). For example, the temperature datum 107 may be obtained from the first temperature sensor 106 at a temperature refresh frequency that is lower than the display refresh frequency. For example, the temperature refresh frequency may be between 1 Hertz and 0.01 Hertz, i.e. the temperature datum 107 may be obtained from the first temperature sensor 106 between once every second and once every 100 seconds. This is advantageous as it reduces processing effort, and the temperature is not expected to change as quickly as the display is refreshed.

The display controller 100 of FIG. 1 allows color-dependent aging effect of pixels of the display device 150 to be compensated during each display refresh in a latency- and bandwidth efficient manner. However, it should be appreciated that the instant display controller 100 can also advantageously be used for a black and white display device, i.e. there could be as few as a single-color component.

The compensation is based on a first aging compensation quantity 170 which may model how the pixel has aged over time of usage, depending on pixel color, the (time-) integrated intensity 201 of the pixel and the (time-)integrated temperature. This way, it is not necessary to measure currents and voltages, for example for individual pixels but the compensation can be done based on a calibrated first aging compensation quantity 170.

The display controller 100 also determines a quantitative measure of how much the current operation, the display of each frame, has aged the pixels in the display device 150 by determining a first incremental aging effect datum 190 for the first color component of the first pixel based on (i) the first initial intensity or the first corrected intensity of the first color component of the first pixel and (ii) the first temperature datum. Advantageously, the determination of the first incremental aging effect datum 190 is based on the first corrected intensity of the first color component of the first pixel since this is more accurate as this is the intensity at which the first pixel is operated.

The term processing unit 104 may include microprocessors, microcontrollers, processor modules or subsystems (including one or more microprocessors or microcontrollers), or other control or computing devices. A processing unit 104 can refer to a single component or to a plurality of components, e.g. a plurality of cores or even several physically distinct processors.

In this example embodiment, the display device 150 is a screen, which could for example be a computer screen, a TV, or a screen for us in an automobile, or any other screen. In this example embodiment, the display device 150 comprises light emitting diodes, in this example organic light emitting diodes, OLEDs. This is advantageous as OLEDs exhibit complex, color-dependent aging effects as illustrated elsewhere herein. Since aging is color-dependent, the white balance of the display device 150 may shift over time, which needs to be compensated. However, the display controller can also advantageously be used for other display devices, especially any light emitting elements that are not stable over time or usage.

In this exemplary embodiment, the temperature datum 107 is obtained from a first temperature sensor 106 arranged on the display device 150. In other embodiments, there may be 2, 3, 4 or more temperature sensors arranged on or near the display device 150. In some embodiments, the location of the first pixel on the display device 150 is taken into account for interpolating temperature data measured by more than one temperature sensor arranged on or near the display device 150 to improve the temperature estimate for the first pixel.

Aspects of the display controller 100 of FIG. 1 allow for an efficient and effective compensation of such color-dependent aging effects.

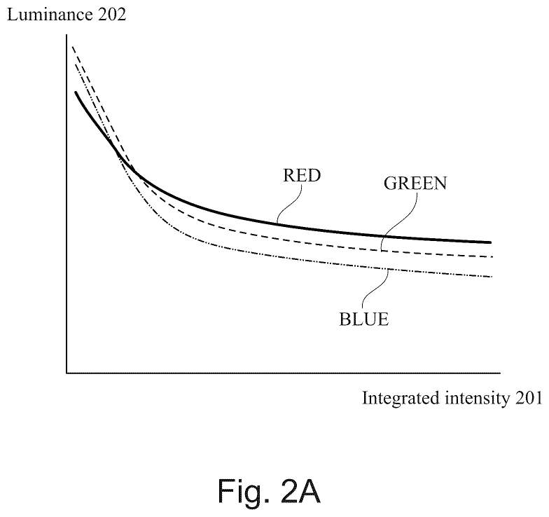

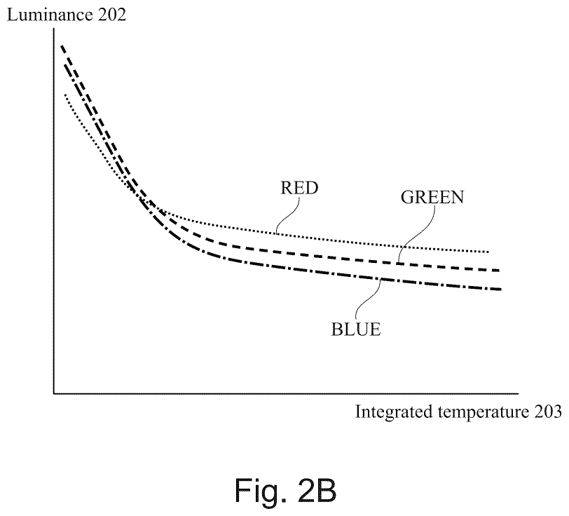

FIG. 2A shows an exemplary aging-related degradation of luminance 202 of a red, green, and blue pixel depending on time-integrated lifetime intensity 201. In this example embodiment, the aging effect is more pronounced for blue pixels than for green or red pixels.

FIG. 2B shows an exemplary aging-related degradation of luminance 202 of a red, green, or blue pixel depending on time-integrated temperature of operation 203. The higher the temperature during operation, the more pronounced is the aging effect on the pixel. In this example embodiment, the aging effect is more pronounced for blue pixels than for green or red pixels.

Curves similar to those shown in FIGS. 2A and 2B can be measured and used for calibration purposes for a display device 150.

It is possible to approximate such curves, for example using polynomials. Thus, in certain embodiments, the first aging compensation quantity 170 may comprise at least one coefficient of a polynomial. In some examples, the first aging compensation quantity 170 may comprise at least two or at least three coefficients. For example, one or more polynomial coefficients may express the relationship of input intensity value and output intensity value for a specific pixel and color component. For example, this is may be generally derived from curves shown in FIGS. 2A and 2B. In certain examples, these curves are disassembled this into several segments and the aging increment assembles the effect expressed in both graphs by approximating a degradation caused by both intensity and temperature for the specific color. This allows for an efficient yet accurate compensation. The polynomials could be split into more than one segment for improved efficiency.

It is possible to use a look-up table based on the determined calibration, for efficiency it is possible to interpolate the look-up table.

In the exemplary embodiment of FIG. 1, the display controller 100 comprises a direct-to-memory access controller, DMA. This advantageously allows to efficiently keep track of the incremental aging effect that the display device 150 experiences during current operation. For example, by performing the required memory access operations with a direct-to-memory access controller, DMA, a CPU need not be involved in these memory operations. Thus, latency is improved and CPU time can used for other, for example more complex operations. The display controller may comprise a second or third direct-to-memory access controller or more direct-to-memory access controllers. It is possible that any memory read and write operations are controlled by a first/second/third direct-to-memory access device. For example, one DMA may be configured for reading data while another DMA is configured for writing data.

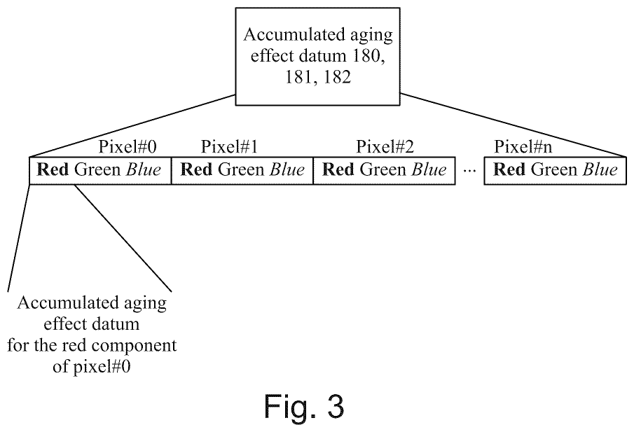

As illustrated with reference to the exemplary embodiment of FIG. 3, there could be three color components, e.g. RGB color components red, green and blue. In that case, for each pixel, the accumulated aging effect datum comprises three components: red, green and blue to allow for a color-dependent aging correction. Similarly, the first 190, second 191, and third 192 incremental aging effect datum and the first 170, second 171, and third 172 aging compensation quantity would comprise three components. Thus, the aging compensation quantity interface 103 is further configured for obtaining a second aging compensation quantity for a second color component of the first pixel from the first memory element and a third aging compensation quantity 172 for a third color component of the first pixel from the first memory element;
wherein the processing unit 104 may be further configured to:
determine a second initial intensity of the second color component of the first pixel based on the first image data, and
determine a third initial intensity of the third color component of the first pixel based on the first image data,
determine a second corrected intensity of the second color component of the first pixel based on the second initial intensity of the second color component of the first pixel and the second aging compensation quantity 171, and
determine a third corrected intensity of the third color component of the first pixel based on the third initial intensity of the third color component of the first pixel and the third aging compensation quantity 172,
determine a second incremental aging effect datum 191 for the second color component of the first pixel based on the second initial intensity or the second corrected intensity of the second color component of the first pixel and the first temperature datum;
determine a third incremental aging effect datum 192 for the third color component of the first pixel based on the third initial intensity or the third corrected intensity of the third color component of the first pixel and the first temperature datum;
wherein the display data interface 130 is further configured for outputting display data 160 comprising the second corrected intensity of the second color component and the third corrected intensity of the third color component of the first pixel to the display device 150 at the display refresh frequency.

The first image data itself may contain all the color components for the first pixel.

However, in other embodiments, there might only be one color component. It is also possible that there are four color components. However, there may be any number of color components, for example, 5, 6, 7, 8, or more color components.

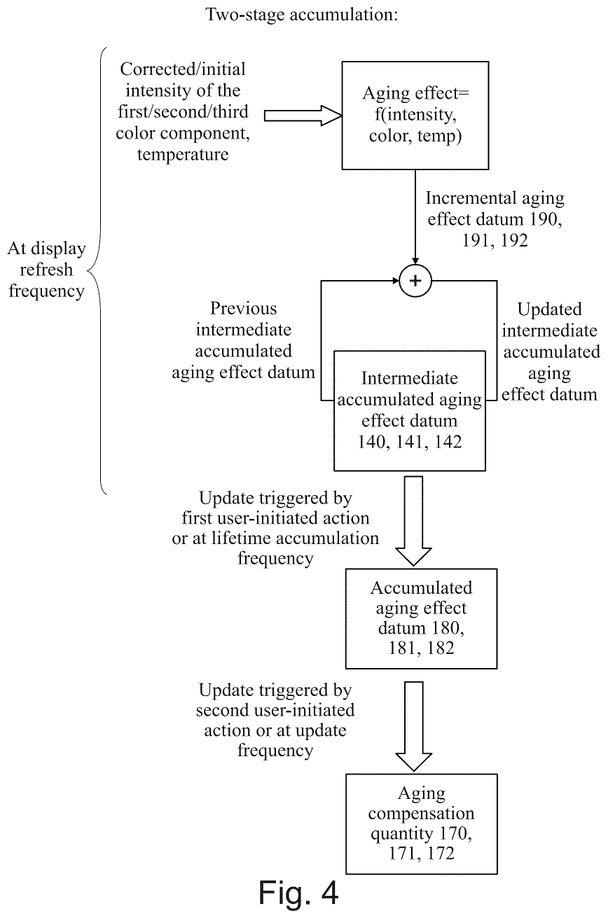

The exemplary embodiment of FIG. 4 illustrates a two-stage accumulation process according to some embodiments of the invention:

The exemplary display controller 100 further comprises an aging accumulator 143 wherein the aging accumulator 143 is configured to update, at the display refresh frequency, a first/second/third intermediate accumulated aging effect datum 140/141/142 based on the first/second/third incremental aging effect datum 190/191/192, respectively. This could for example comprise consecutively adding the first/second/third incremental aging effect datum 190/191/192 to a previous value of the first/second/third intermediate accumulated aging effect datum 140/141/142, respectively. For example, the first/second/third intermediate accumulated aging effect datum 140/141/142 may be stored on the second memory element 112 which may be external to the display controller. The second memory element 112 may be fast but volatile.

The exemplary aging accumulator 143 is further configured to update a first/second/third accumulated aging effect datum 180/181/182 based on the first/second/third intermediate accumulated aging effect datum 140/141/142 at a lifetime accumulation frequency that is lower than the display refresh frequency and/or triggered by a first user-initiated action. After updating the first/second/third accumulated aging effect datum 180/181/182, the first/second/third intermediate accumulated aging effect datum 140/141/142 may be reset, e.g. to zero. For example, the first user-initiated action could be a shutdown or a start-up or the pressing of an “update accumulation” button, e.g. in the settings menu of a display system, or it could be a remotely triggered action, for example part of an update by the manufacturer. The lifetime accumulation frequency might be adjustable, for example it could be adjusted by a user in a settings menu. Thus, it does not need to remain the same for the whole lifetime of the display.

For example, the exemplary aging accumulator 143 may be configured to update the first/second/third accumulated aging effect datum 180/181/182 based on the first/second/third intermediate accumulated aging effect datum 140/141/142 at a lifetime accumulation frequency, e.g. once an hour, that is lower than the display refresh frequency and additionally at every shutdown.

For example, the first/second/third accumulated aging effect datum 180/181/182 could be stored on the third memory element 113 which may be non-volatile (also for the one-stage accumulation described herein).

For example, the first/second/third intermediate accumulated aging effect datum 140/141/142 could store the accumulation over an operating-cycle and the first/second/third accumulated aging effect datum 180/181/182 could store the accumulation over the lifetime of the display device.

This two-stage accumulation has the advantage of using a lower bandwidth for memory access. For example, the first/second/third intermediate accumulated aging effect datum 140/141/142 may each comprise a first bit-depth and the first/second/third accumulated aging effect datum 180/181/182 may each comprise a second bit-depth (e.g. 32 bits), which is greater than the first bit-depth (e.g. 16 bits).

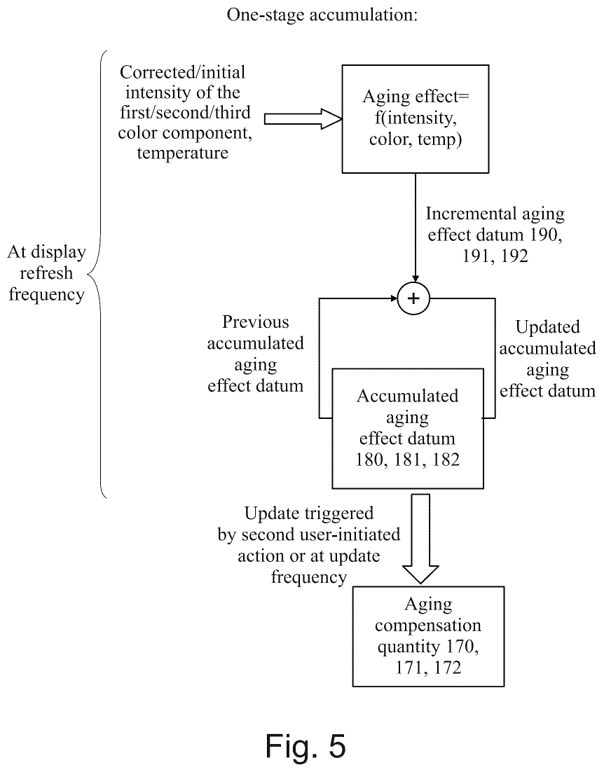

The exemplary embodiment of FIG. 5 illustrates a one-stage accumulation process according to some embodiments of the invention: in this example, the aging accumulator 143 is configured to update a first/second/third accumulated aging effect datum 180/181/182 based on the first/second/third incremental aging effect 190/191/192 datum at the display refresh frequency. This could for example comprise consecutively adding the first/second/third incremental aging effect datum 190/191/192 to a previous value of the first/second/third accumulated aging effect datum 140/141/142, respectively. There is no intermediate stage in this case. This one-stage accumulation has the advantage of being simpler to implement.

For two-stage or one-stage accumulation, the exemplary processing unit 104 is further configured to update the first/second/third aging compensation quantity 170/171/172 for the first/second/third color component of the first pixel based on the first/second/third accumulated aging effect datum 180/181/182; wherein the update of the first/second/third aging compensation quantity 170/171/172 is triggered by a second user-initiated action and / or performed periodically at an update frequency, wherein the update frequency is lower than the display refresh frequency.

For example, the second user-initiated action could be a shutdown or a start-up or the pressing of an “update aging compensation” button, e.g. in the settings menu of a display system or it could be a remotely triggered action, for example part of an update by the manufacturer. For example, the first user-initiated action could be identical to the second user-initiated action.

For example, the update of the first/second/third aging compensation quantity 170/171/172 may be triggered by a shutdown (an exemplary second user-initiated action) and additionally be performed periodically at an update frequency, e.g. once every hour, wherein the update frequency is lower than the display refresh frequency.

Since aging is not expected to progress on the time scale of typical display refresh frequencies, e.g. 60 Hertz, it saves computing resources to update the first 170, second 171, and third 172 aging compensation quantity at a lower rate than the display refresh frequency.

The update frequency may be lower than or equal to the lifetime accumulation frequency. For example, the lifetime accumulation frequency could be identical to the update frequency.

For two-stage or one-stage accumulation, the aging accumulator may be implemented in hardware, e.g. in the processing unit 104 and/or one or more DMAs, and/or software.

In the exemplary embodiment of FIG. 1, the image data interface 101 is further configured for obtaining second image data from a second frame buffer and the processing unit 104 is further configured to determine the first initial intensity of the first color component of the first pixel based on the first image data and the second image data. For example, the color intensity, e.g. the first/second/third initial intensity, could result from a blending of image data obtained from multiple framebuffers by the display controller.

The use of a second frame buffer reduces latency due the repeated filling and reading of the frame buffer. In other embodiments, there may be a third frame buffer or even more frame buffers.

In this exemplary embodiment, the processing unit 104 is further configured to:
determine the second initial intensity of the second color component of the first pixel based on the first image data and the second image data, and
determine the third initial intensity of the third color component of the first pixel based on the first image data and the second image data. Thus, latency is reduced for three color components.

The second image data itself may contain all the color components for the first pixel.

The exemplary embodiment of FIG. 1 also shows a display system 300 comprising: a display controller 100 as provided according to any aspect herein, a display connectable to the display data interface 130 of the display controller 100, the first memory element 111, the second memory element 112, the third memory element 113, the first frame buffer 121, and the first temperature sensor 106. In the exemplary embodiment of FIG. 1, the display system 300 additionally comprises the second frame buffer 122. The display system 300 advantageously allows aging effects to be compensated efficiently by the display controller 100.

The first 111, second 112 and third 113 memory element could be part of the same physical memory as the first 121 and second 122 frame buffer, e.g. the external memory 110. For example, external memory 110 may comprise dynamic random-access memory, DRAM. However, it is also possible that these are comprised in different physical memories.

FIG. 5 shows an exemplary embodiment of a method 500 performed by a display controller 100 comprising:
obtaining 501 first image data from a first frame buffer via an image data interface 101;
obtaining 502 a first temperature datum from a first temperature sensor 106;
obtaining 503 a first aging compensation quantity for a first color component of a first pixel from a first memory element via an aging compensation quantity interface 103;
rendering 504, by a processing unit 104 of the display controller 100, display data 160 at a display refresh frequency, the rendering comprising:
determining 505 a first initial intensity of the first color component of the first pixel based on the first image data,
determining 506 a first corrected intensity of the first color component of the first pixel based on the first initial intensity of the first color component of the first pixel and the first aging compensation quantity, and
determining 507 a first incremental aging effect datum 190 for the first color component of the first pixel based on (i) the first initial intensity or the first corrected intensity of the first color component of the first pixel and (ii) the first temperature datum; and
outputting 508, via a display data interface 130, the display data 160 comprising the first corrected intensity of the first color component of the first pixel to a display device 150 at the display refresh frequency.

The instructions and/or flowchart steps in FIG. 5 can be executed in any order, unless a specific order is explicitly stated.

Also, those skilled in the art will recognize that while one example set of instructions/method has been discussed, the material in this specification can be combined in a variety of ways to yield other examples as well, and are to be understood within a context provided by this detailed description.

For example, any aspect described herein with respect to a system or display controller 100 may correspond to a method and method step.

According to a third aspect of the present disclosure, there is provided a computer program comprising instructions that, when executed by a display controller 100, causes the display controller 100 to perform a method according to any aspect provided herein.

In the exemplary embodiment of FIG. 1, the display controller 100 comprises on-chip memory 105, which comprises a non-transient machine-readable storage medium comprising instructions that, when executed by a display controller, causes the display controller to:
obtain first image data from a first frame buffer via an image data interface;
obtain a first temperature datum from a temperature sensor;
obtain a first aging compensation quantity for a first color component of a first pixel from a first memory element via an aging compensation quantity interface;
render, by a processing unit of the display controller, display data at a display refresh frequency, the rendering comprising:
determining a first initial intensity of the first color component of the first pixel based on the first image data,
determining a first corrected intensity of the first color component of the first pixel based on the first initial intensity of the first color component of the first pixel and the first aging compensation quantity, and
determining a first incremental aging effect datum for the first color component of the first pixel based on (i) the first initial intensity or the first corrected intensity of the first color component of the first pixel and (ii) the first temperature datum; and
output, via a display data interface, the display data comprising the first corrected intensity of the first color component of the first pixel to a display device at the display refresh frequency.

The non-transitory machine-readable storage medium may comprise instructions that, when executed by display controller 100, causes the display controller 100 to perform any method or any of the functions described herein. For example, on-chip memory 105 may comprise static random-access memory, SRAM.

In this specification, example embodiments have been presented in terms of a selected set of details. However, a person of ordinary skill in the art would understand that many other example embodiments may be practiced which include a different selected set of these details. It is intended that the following claims cover all possible example embodiments.

### LIST OF REFERENCE SIGNS

100 Display controller
101 Image data interface
102 Temperature data interface
103 Aging compensation quantity interface
104 Processing unit
105 On-chip memory
106 First temperature sensor
107 Temperature datum
110 External memory
111 First memory element
112 Second memory element
121 First frame buffer
122 Second frame buffer
130 Display data interface
131 Direct-to-memory access controller
140 First intermediate accumulated aging effect datum
141 Second intermediate accumulated aging effect datum
142 Third intermediate accumulated aging effect datum
143 Aging accumulator
150 Display device
160 Display data
170 First aging compensation quantity
171 Second aging compensation quantity
172 Third aging compensation quantity
180 First accumulated aging effect datum
181 Second accumulated aging effect datum
182 Third accumulated aging effect datum
190 First incremental aging effect datum
191 Second incremental aging effect datum
192 Third incremental aging effect datum
201 Integrated intensity
202 Luminance
203 Integrated temperature
300 Display system

1. A display controller comprising:
an image data interface for obtaining first image data from a first frame buffer;
a temperature data interface for obtaining a first temperature datum from a first temperature sensor;
an aging compensation quantity interface for obtaining a first aging compensation quantity for a first color component of a first pixel from a first memory element;
a processing unit configured for rendering display data at a display refresh frequency, wherein the processing unit is configured to:
determine a first initial intensity of the first color component of the first pixel based on the first image data,
determine a first corrected intensity of the first color component of the first pixel based on the first initial intensity of the first color component of the first pixel and the first aging compensation quantity, and
determine a first incremental aging effect datum for the first color component of the first pixel based on (i) the first initial intensity or the first corrected intensity of the first color component of the first pixel and (ii) the first temperature datum; and
a display data interface for outputting the display data comprising the first corrected intensity of the first color component of the first pixel to a display device at the display refresh frequency.

2. The display controller of claim 1, wherein the display device comprises light emitting diodes.

3. The display controller according to claim 1, wherein the first aging compensation quantity comprises at least one coefficient of a polynomial.

4. The display controller according to claim 1, further comprising an aging accumulator wherein the aging accumulator is configured to update, at the display refresh frequency, a first intermediate accumulated aging effect datum based on the first incremental aging effect datum; and wherein the aging accumulator is further configured to update a first accumulated aging effect datum based on the first intermediate accumulated aging effect datum at a lifetime accumulation frequency that is lower than the display refresh frequency and/or triggered by a first user-initiated action.

5. The display controller according to claim 1, further comprising an aging accumulator wherein the aging accumulator is configured to update a first accumulated aging effect datum based on the first incremental aging effect datum at the display refresh frequency.

6. The display controller according to claim 4, wherein:
at least one of triggered by a second user-initiated action or performed periodically at an update frequency, wherein the update frequency is lower than the display refresh frequency.

7. The display controller of claim 1, wherein the aging compensation quantity interface is further configured for obtaining a second aging compensation quantity for a second color component of the first pixel from the first memory element and a third aging compensation quantity for a third color component of the first pixel from the first memory element; wherein the processing unit is further configured to:
determine a second initial intensity of the second color component of the first pixel based on the first image data,
determine a third initial intensity of the third color component of the first pixel based on the first image data,
determine a second corrected intensity of the second color component of the first pixel based on the second initial intensity of the second color component of the first pixel and the second aging compensation quantity,
determine a third corrected intensity of the third color component of the first pixel based on the third initial intensity of the third color component of the first pixel and the third aging compensation quantity,
determine a second incremental aging effect datum for the second color component of the first pixel based on the second initial intensity or the second corrected intensity of the second color component of the first pixel and the first temperature datum; and
determine a third incremental aging effect datum for the third color component of the first pixel based on the third initial intensity or the third corrected intensity of the third color component of the first pixel and the first temperature datum;
wherein the display data interface is further configured for outputting display data comprising the second corrected intensity of the second color component and the third corrected intensity of the third color component of the first pixel to the display device at the display refresh frequency.

8. The display controller according to claim 7, wherein:
the aging accumulator is further configured to update, at the display refresh frequency, a second intermediate accumulated aging effect datum based on the second incremental aging effect datum, and wherein the aging accumulator is further configured to update a second accumulated aging effect datum based on the second intermediate accumulated aging effect datum at least one of periodically at the lifetime accumulation frequency or triggered by the first user-initiated action; and
wherein the aging accumulator is further configured to update, at the display refresh frequency, a third intermediate accumulated aging effect datum based on the third incremental aging effect datum, and wherein the aging accumulator is further configured to update a third accumulated aging effect datum based on the third intermediate accumulated aging effect datum at at least one of the lifetime accumulation frequency or triggered by the first user-initiated action.

9. The display controller according to claim 7, wherein the aging accumulator is further configured to update a second accumulated aging effect datum based on the second incremental aging effect datum at the display refresh frequency, and wherein the aging accumulator is further configured to update a third accumulated aging effect datum based on the third incremental aging effect datum at the display refresh frequency.

10. The display controller according to claim 8, wherein the processing unit is further configured to update the second aging compensation quantity for the second color component of the first pixel based on the second accumulated aging effect datum, and
wherein the processing unit is further configured to update the third aging compensation quantity for the third color component of the first pixel based on the third accumulated aging effect datum;
wherein the update of the second and third aging compensation quantity is performed by at least one of being triggered by the second user-initiated action or periodically at an update frequency, wherein the update frequency is lower than the display refresh frequency.

11. The display controller of claim 1, wherein the image data interface is further configured for obtaining second image data from a second frame buffer and wherein the processing unit is configured to determine the first initial intensity of the first color component of the first pixel based on the first image data and the second image data.

12. The display controller according to claim 11, wherein the processing unit is configured to:
determine the second initial intensity of the second color component of the first pixel based on the first image data and the second image data, and
determine the third initial intensity of the third color component of the first pixel based on the first image data and the second image data.

13. A display system comprising: a display controller according to claim 1, a display connectable to the display data interface of the display controller, the first memory element, the first frame buffer, and the temperature sensor.

14. A method performed by a display controller comprising:
obtaining first image data from a first frame buffer via an image data interface;
obtaining a first temperature datum from a temperature sensor;
obtaining a first aging compensation quantity for a first color component of a first pixel from a first memory element via an aging compensation quantity interface;
rendering, by a processing unit of the display controller, display data at a display refresh frequency, the rendering comprising:
determining a first initial intensity of the first color component of the first pixel based on the first image data,
determining a first corrected intensity of the first color component of the first pixel based on the first initial intensity of the first color component of the first pixel and the first aging compensation quantity, and
determining a first incremental aging effect datum for the first color component of the first pixel based on (i) the first initial intensity or the first corrected intensity of the first color component of the first pixel and (ii) the first temperature datum; and
outputting, via a display data interface, the display data comprising the first corrected intensity of the first color component of the first pixel to a display device at the display refresh frequency.

15. A computer program comprising instructions that, when executed by a display controller, causes the display controller to perform a method according to claim 14.

16. The method of claim 14, wherein the display device comprises light emitting diodes.

17. The method according to claim 14, wherein the first aging compensation quantity comprises a coefficient of a polynomial.

18. The method according to claim 14, further comprising:
updating, by an aging accumulator of the display controller, at the display refresh frequency, a first intermediate accumulated aging effect datum based on the first incremental aging effect datum; and
updating, by the aging accumulator, a first accumulated aging effect datum based on the first intermediate accumulated aging effect datum at at least one of a lifetime accumulation frequency that is lower than the display refresh frequency or triggered by a first user-initiated action.

19. The display controller according to claim 1, wherein the temperature datum is obtained from the first temperature sensor at a temperature refresh frequency that is lower than the display refresh frequency.

20. The display controller according to claim 1, wherein the temperature data interface is further configured for obtaining a second temperature datum from a second temperature sensor and the processing unit is configured to determine the first incremental aging effect datum for the first color component of the first pixel additionally based on the second temperature datum.
